(19) United States
(12) Patent Application Publication
(10) Pub. No.: US 2019/0184490 A1
(43) Pub. Date: Jun. 20, 2019

(54) DEVICE AND METHOD FOR SEPARATING A BANDEROLE

(71) Applicant: GIESECKE+DEVRIENT CURRENCY TECHNOLOGY GMBH, München (DE)

(72) Inventor: Michael STAPFER, Neubiberg (DE)

(73) Assignee: GIESECKE+DEVRIENT CURRENCY TECHNOLOGY GMBH, München (DE)

(21) Appl. No.: 16/311,521

(22) PCT Filed: Jun. 23, 2017
(86) PCT No.: PCT/EP2017/000734

§ 371 Date: Dec. 19, 2018

(30) Foreign Application Priority Data
Jun. 27, 2016 (DE) 10 2016 007 833.2

(51) Int. Cl. B23K 26/035; B65B 69/00; G07D 11/16

(52) U.S. Cl. CPC B23K 26/037; G07D 11/16; B65B 69/0025

(57) ABSTRACT

An apparatus and a corresponding method for separating a band of a bundle of documents have a deformation device which is devised to deform the bundle, in particular to bulge the bundle, such that a portion of the band lifts from the bundle, and a separating device which is devised to at least partly cutting through the band in the region of the portion lifted from the bundle. A value-document processing system includes such an apparatus.

The invention relates to an apparatus and a method for separating a band of a bundle of documents, in particular of value documents such as bank notes, according to the preamble of the independent claims as well as a value-document processing system.

From EP 0 761 548 B1 an apparatus is known for separating a bundle of sheets furnished with a band in which a cutting means at an abutting edge of the bundle between two sheets penetrates at least partly into the bundle and cuts the band by a relative motion effectuated between the cutting means and the band. As a cutting means, for example, a rotating cutter is employed. In order that the cutting means upon penetrating the bundle do not damage the sheet goods, an additional element for spreading the bundle is required, for example in the form of a tip arranged before the cutting means.

It is the object of the invention to state an apparatus, a method and a value-document processing system which enables a separating of bands possible in a simple and reliable manner.

This object is achieved by an apparatus and a method according to the independent claims as well as a paper-of-value document processing system having such an apparatus.

The apparatus according to the invention for separating a band of a bundle of documents, in particular value documents such as bank notes, is characterized by a deformation device which is devised to deform, in particular to bulge, the bundle such that a portion of the band lifts from the bundle, and a separating device which is devised to at least partly cutting through the band in the region of the portion lifted from the bundle.

The method according to the invention for separating a band of a bundle of documents, in particular value documents such as bank notes, is characterized in that the bundle is deformed, in particular bulged, such that a portion of the band lifts from the bundle, and the band in the region of the portion lifted from the bundle is cut through at least partly.

The value-document processing system according to the invention has at least one apparatus for processing, in particular for singling and/or conveying and/or checking and/or counting and/or sorting, documents, in particular value document such as bank notes, as well as an apparatus according to the invention.

An aspect of the invention is based on the approach of deforming the bundle, in particular bulging it, such that at least one portion of the band surrounding the bundle lifts from the bundle and in the process no longer lies planarly against the bundle, but runs spaced from the bundle. The portion of the band spaced from the bundle is then cut through by means of a separating device, so that the band can finally be removed from the bundle. By the cutting through of the portion of the band spaced from the bundle, a damage of the bundle or the contained value documents upon the cutting through can be avoided in a simple manner and reliably.

Even if the lifted portion of the band is cut through by the separating device preferably completely, to be able to remove this particularly easily from the bundle, the advantageous effect of the invention already takes effect when the portion lifted from the bundle is cut through by the separating device only partly. Also in this case the band partly cut through in the manner according to the invention, so to speak “torn” or weakened, can for example upon a subsequent tearing-off of the band be completely torn in two and finally reliably removed from the bundle.

Altogether, the invention makes a separating of bands possible in a simple and reliable manner.

Lifting a portion of the band from the bundle in the sense of the invention is to be understood as any operation in which, by deforming the bundle, a distance is created between a portion of the band, on the one hand, and the part of the bundle located in the region of this portion, on the other hand. A lifting of the portion of the band can therefore also be obtained by lowering the part of the bundle located in this portion relative to this portion of the band.

In a preferred embodiment of the invention, the deformation device is devised to concavely bulge the bundle in the region of one of the principal surfaces which are formed by the two outermost value documents of the bundle, whereby the portion of the band running in the region of this principal surface lifts from this principal surface. By bulging the bundle in the region of one of the principal surfaces, the distance required for a reliable cutting through of the band between the relevant portion of the band and the bundle can be realized in a particularly simple and reliable manner.

Preferably, the separating device is devised for generating a laser beam by which the band can be cut through at least partly. By a cutting-through of the band by means of laser beam, the reaction forces usually occurring upon the employment of mechanical cutting means are eliminated in the band, so that further mechanical measures for intercepting these reaction forces can be omitted. The structure of the apparatus is thereby further simplified.

Preferably, the laser beam is focused on the portion of the band lifted from the bundle which should be cut through. The band material, such as paper or plastic, is evaporated in an efficient manner by the laser beam focused onto the band. In contrast, the energy density of the laser beam is distinctly lower outside the focus region—and with it also in the region of the part of the bundle spaced from the lifted portion of the band—so that a damage by the laser beam of the value document of the bundle lying there is prevented. In this manner, a secure separating of the bundle is guaranteed by means of an particularly simple construction.

In a further preferred embodiment, a baffle element substantially opaque to electromagnetic radiation is provided which is devised to be incorporated between the portion of the band lifted from the bundle and the bundle. Preferably, the baffle element is devised to absorb electromagnetic radiation at least partly. Such a baffle element can be provided additionally or alternatively for a focusing of the laser beam onto the portion of the band lifted from the bundle and prevents in a simple and reliable manner that parts of the laser radiation strike the part of the bundle spaced from the lifted portion of the band and can possibly damage value documents there.

In a further preferred embodiment, the deformation device further has a stamp element which is devised to press on the bundle lying on the at least one support element. In this connection, the at least one support element and the stamp element are arranged and/or shaped such that the bundle is concavely bulged by the stamp element pressing on the bundle. In this way, the deformation of the bundle required for lifting the band from the bundle can be realized in a particularly simple and reliable manner.

Preferably, the at least one support element has at least one opening by which air can be sucked off. Alternatively or additionally, the support element and/or the opening can be configured such that the cut-through band can be removed from the bundle through the opening. The latter can be realized in particular by generating a negative pressure in the region of the opening whereby the band is sucked off through the opening. In this way, the bundle can be fixed on the at least one support element in a simple and reliable manner or the cut-through band be removed from the bundle.

In a further preferred embodiment, the support element has a cross section which tapers toward the opening of the support element, so that the bundle lying on the support element upon a sucking of air through the opening adapts itself at least partly to the tapering cross section of the support element and is in the process concavely bulged. The deformation of the bundle required for a spacing of a portion of the band is in this way also realized in a particularly simple and reliable way.

Further advantages, features and application possibilities of the present invention will result from the subsequent description in connection with the figures. There are shown:

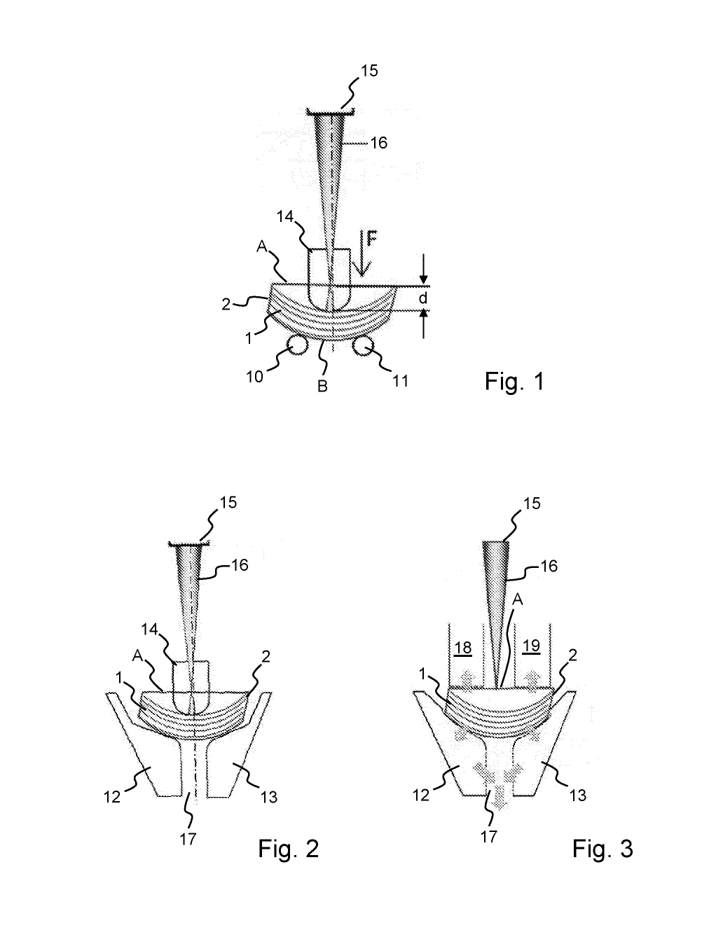

FIG. 1 a first example of an apparatus for separating a band of a bundle in a front view;

FIG. 2 a second examples of the apparatus in a front view;

FIG. 3 a third examples of the apparatus in a front view;

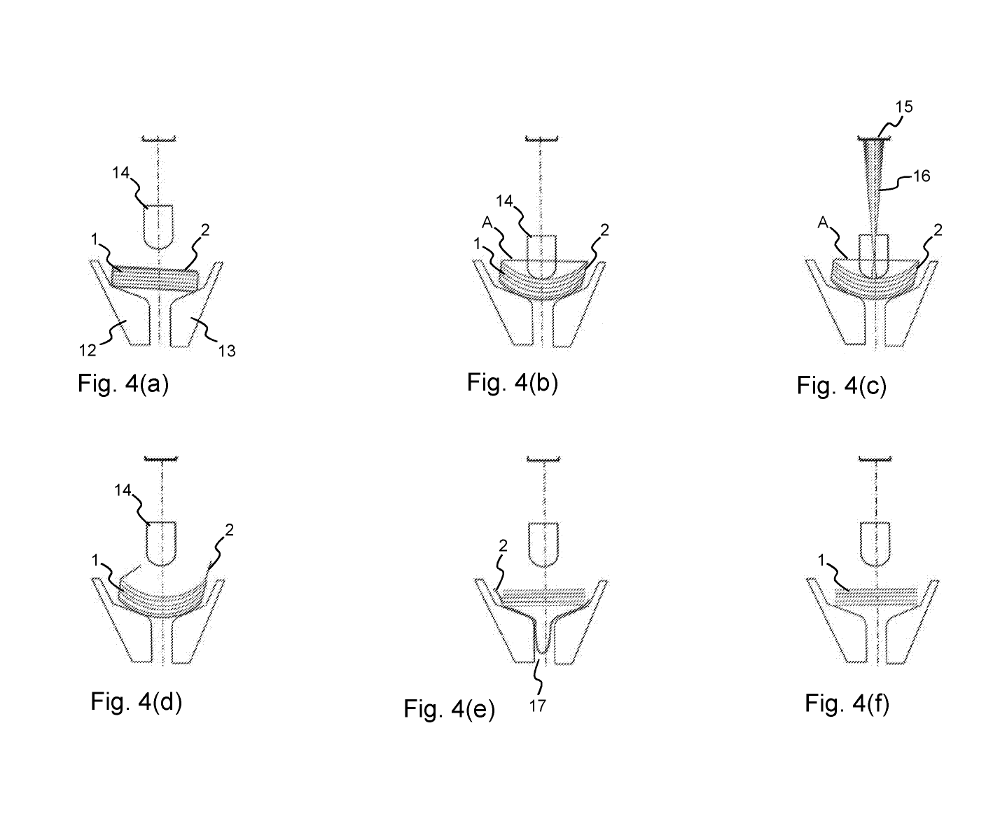

FIG. 4 individual steps a) to f) of a method for separating a band of a bundle;

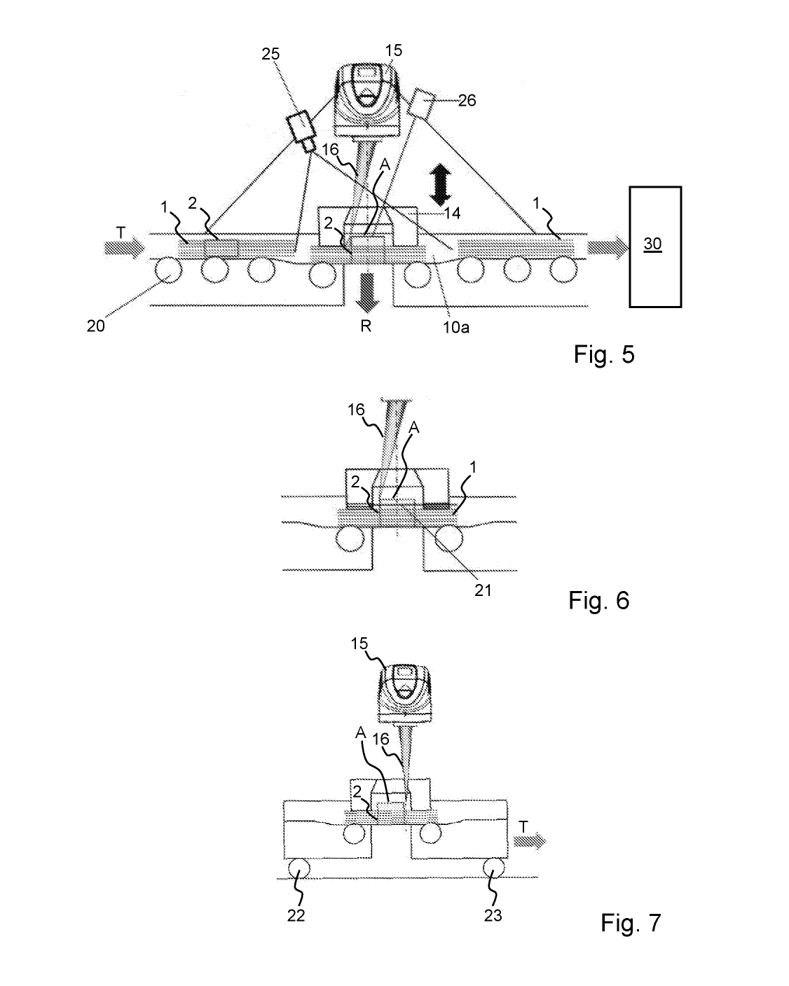

FIG. 5 a fourth examples of the apparatus in a side view;

FIG. 6 a fifth examples of the apparatus in a side view; and

FIG. 7 a sixth examples of the apparatus in a side view.

FIG. 1 shows a first example of an apparatus for separating a band 2 of a bundle 1 of documents, in particular value documents such as bank notes, in a schematic front view. The bundle 1 lies on top on of two spaced-apart support elements 10 and 11. Further, a stamp element 14 is provided which can be driven up to the bundle 1 lying on the support elements 10 and 11 and in the process deforms the initially substantially cuboid bundle, by pressing this with a force F against the support elements 10 and 11 and in the process forming a concave bulge on the upper side facing the stamp element 14 and a convex one on the underside facing the support elements 10 and 11. In the process, the portion A running at the upper side of the bundle 1 of band 2 running around the bundle 1 is lifted from the upper side of the bundle 1, wherein the maximum distance d between the portion A of the band 2 and the concavely bulged upper side of the bundle 1 preferably lies between 5 and 20 mm, in particular between about 10 and 15 mm. It is self-evident that the stamp element 14 may not be moved up to the bundle 1 in the region of the band 2.

Further, a light source 15, in particular in the form of a laser, is provided which generates a light beam 16 directed at the portion A of the band 2 lifted from the bundle 1. Preferably, the light beam 16, as is indicated in the present example, is focused on the portion A of the band 2. This is attained by a corresponding embodiment of the light source 15 itself and/or additional optical elements (not represented) in the beam path.

By the focusing of the light beam 16 on the portion A of the band 2, the light intensity is the highest there, so that upon choosing a light source 15 having a correspondingly high intensity, the material of the band 2, for example paper and/or plastic, evaporates, whereby the band 2 is cut through. A cutting-through of the band 2, preferably over the entire band width, can be attained for example by the fact that the light beam 16 is focused in a line which extends over the width of the band 2. Alternatively or additionally, it is, however, also possible to move the light beam 16 and the bundle 1 furnished with the band 2 relative to each other.

A focusing of the light beam 16 on the portion A of the band 2 further has the advantage that the light of the light beam 16 striking the value document of the bundle 1 lying below the portion A of the band 2 at the distance d lies outside the focus region and with it has a lower energy density than in the focus region, so that the value document of the bundle 1 cannot be damaged by the light beam 16.

In the second example of the apparatus shown in FIG. 2, the support elements 12 and 13 form a support means for the bundle 1, wherein the cross section of the support means tapers toward the opening 17 located between the two support elements 12 and 13. As in the first example of the apparatus shown in FIG. 1, likewise in the second example represented here a stamp element 14 is provided by which the bundle 1 is pressed against the support means and in the process concavely bulged, so that the upper portion A of the band 2 is lifted from the upper side of the bundle 1. Furthermore, the statements in connection with the first example shown in FIG. 1 apply accordingly.

FIG. 3 shows a third example of the apparatus, in which, as in the second example shown in FIG. 2, the support elements 12 and 13 form a supporting surface tapering toward an opening 17 for the bundle 1. Instead of a stamp element pressing from above on the bundle 1, in the present example a deformation of the bundle 1 is attained by the fact that a negative pressure is generated in the opening 17 by which the bundle 1 is deformed in the manner represented in the figure and in the process is concavely bulged on the upper side as in the examples shown in FIGS. 1 and 2. Preferably, air intake channels 18 and 19 can additionally be provided in the region of the upper portion A of the band 2 through which the portion A of the band 2 is sucked in, so that this lifts reliably from the upper side of the bundle 1 upon the concave bulging of the bundle 1. Furthermore, in particular in view of the cutting-through of the portion A of the band 2 by means of light beam 16, the above-mentioned statements hold accordingly in connection with FIG. 1.

Preferably the air intake is controlled by the opening 17 and/or the channels 18 and/or 19 such that the band 2 cut through in the portion A is sucked off through the opening 17 or one of the channels 18 or 19. For example, the cut-through band 2 can be sucked off through the channel 18, after the negative pressure at the opening 17 and at the channel 19 is switched off. Alternatively, it is also possible to draw the band through the opening 17, by switching off the negative pressure in the channels 18 and 19.

FIG. 4 shows individual steps a) to f) of a method for separating a bundle 1 of value documents furnished with a band 2;

In a first step a), the substantially cuboid bundle 1 is positioned on a support means, which in the shown example is formed by support elements 12 and 13, below a stamp element 14.

In a second step b), the bundle 1 is pressed onto the support means by introducing the stamp element 14 and is in the process concavely bulged, so that an upper portion A of the band 2 lifts from the upper side of the bundle 1.

In a third step c), the upper portion A of the band 2 is cut through by a light beam 16 focused on the portion A.

In a fourth step d), the stamp element 14 moves back from the bundle 1, so that this can again assume the original cuboid shape.

In a fifth step e), the cut-through band 2 is sucked off through opening 17 by creating a negative pressure at said opening, so that the debanded bundle 1 can finally be transported off from the support means in a step f) and be fed to a further processing.

FIG. 5 shows a fourth example of the apparatus in a strongly schematized side view. A paper-of-value bundle 1 furnished with a band 2 is fed by means of a transport device 20 in transport direction T to a region in which the bundle 1 furnished with the band 2 is separated in the manner described more closely hereinabove. In the process, the bundle 1 is pressed by the stamp element 14 against an accordingly shaped support means 10a and in the process deformed, in particular concavely bulged, in such a way that the upper portion A of the band 2 lifts from the upper side of the bundle 1 and is cut through by means of a focused laser beam 16.

The laser beam 16 is preferably generated by a so-called marking or inscription laser which has an internal mirror deflection by which the beam 16 can be guided over the portion A of the band 2 and in the process cuts through this. The cut-through band 2 is then removed from the bundle 1, for example by sucking off in the direction R.

Preferably, an image-capturing device 25 is provided which can capture the position of the bundle 1 and/or the band 2. In a control device (not represented) the feed and/or the positioning of the bundle 1 or the band 2 can then be controlled based on the captured position of the bundle 1 or the band 2. On the basis of the captured images of the bundle 1 or the band 2, a distance measuring can optionally also be performed in the control device to perform, for example, a targeted focusing of the light beam 16 onto the portion A of the band 2. The images recorded by means of image capture can also be archived to be able to retrace, if necessary, the individual process steps upon separating the bundle 1. Alternatively or additionally, is can also be checked on the basis of the recorded images whether the band 2 was removed correctly. Alternatively or additionally, it is also possible to configure the image capturing device 25 such that this uses an internal positioning aid of the light source 15, in particular of the marking or inscription laser. Alternatively or additionally, it is also possible to configure the image capturing device 25 such that this captures information items present on the band 2 which can be employed upon a subsequent processing in a value-document processing apparatus 30.

Alternatively or additionally, a device 26 can also be provided for distance measuring by means of which the height of the focus of the light beam 16 is adapted to the current position, in particular height, of the portion A of the band 2.

After the cutting-open of the bundle 1 and removing of the band 2, the value documents of the debanded bundle 1 can be fed to a further processing in the value-document processing apparatus 30, which is indicated only schematically.

FIG. 6 shows a fifth example of the apparatus in a side view having a movable baffle element 21 which can be introduced after a concave bulging of the bundle 1 between the portion A of the band 2 lifting from the upper side of the bundle 1 on the one hand, and the upper side of the bundle 1 on the other hand, before the portion A of the band 2 is cut through by the focused light beam 16. The baffle element 21 is substantially opaque to the light of the light beam 16 and prevents that this can strike onto the bundle 1 and possibly damage the upper value documents. After cutting through the portion A of the band 2, the baffle element 21 can again be moved out of the region of the band 2 or bundle 1. Preferably the baffle element 21 is configured as a metallic, non-reflective slide.

FIG. 7 shows a sixth example of the apparatus in a side view, in which, unlike the examples shown in FIGS. 5 to 6, not the light beam 16 is deflected, but the deformed bundle 1 is guided in transport direction T by means of a suitable transport device, which is indicated only schematically by rollers 22, past the fixed-in-place light beam 16 whose focus point then successively cuts through the portion A of the band 2 until this is finally completely cut open.

According to an alternative or additional aspect of the invention, the apparatus can be configured such that packages can be separated or opened with the light beam 16 in which several bundles of value documents are packaged, in particular furnished with bands. Such packages can be e.g. packages from foils, in particular shrink films, and/or vacuum packages. Preferably, the packaged bundles are lined up adjacently such that the bands of the individual bundles lie in a line and have at least a certain overlap.

In the process, the apparatus preferably has a device by which a package is rotated under the light beam 16 by 360° and/or is displaced relative to the light beam 16. Preferably the device is configured to continually change the distance of the rotation axis to the focus point during the rotation in such a way that the surface of the package always lies in the focus of the light beam 16.

During the relative motion of package and light beam 16, this successively cuts through the packaging foil lying tightly against the combined bundles along their circumference, whereas excess energy of the light beam 16 is absorbed by the bands lying under the cut line of the bundles. In general the excess energy is lower than the energy required for separating the band material, so that the value documents located in the respective bundles are reliably protected by the bands from damage. The bands can possibly have light scorch marks, which does no matter if these are thereupon removed from the bundles, in particular in the hereinabove described manner.

Besides the hitherto described light source as a separating device 15 for the cutting of the band 2, other means can be employed for the cutting through of the band 2, for example knifes or blades.

1.-12. (canceled)

13. An apparatus for separating a band of a bundle of documents, comprising
a deformation device which is devised to deform the bundle such that a portion of the band lifts from the bundle, and
a separating device which is devised to at least partly cut through the band in the region of the portion lifted from the bundle.

14. The apparatus according to claim 13, wherein the bundle has two principal surfaces which are formed by the two outermost value documents of the bundle, and the deformation device is devised to concavely bulge the bundle in the region of one of the principal surfaces, wherein the portion of the band running in the region of this principal surface lifts from this principal surface.

15. The apparatus according to claim 13, wherein the separating device is devised for generating a laser beam by which the band can be cut through at least partly.

16. The apparatus according to claim 15, wherein the laser beam is focused on the portion of the band lifted from the bundle.

17. The apparatus according to claim 13, having a baffle element substantially opaque to electromagnetic radiation which is devised to be incorporated between the portion of the band lifted from the bundle and the bundle.

18. The apparatus according to claim 17, wherein the baffle element is devised to absorb electromagnetic radiation at least partly.

19. The apparatus according to claim 13, wherein the deformation device has at least one support element which the bundle can lie on top of.

20. The apparatus according to claim 19, wherein the deformation device further has a stamp element which is devised to press on the bundle lying on the at least one support element,
wherein the at least one support element and the stamp element are arranged and/or shaped such that the bundle is concavely bulged by the stamp element pressing on the bundle.

21. The apparatus according to claim 19, wherein the at least one support element has at least one opening by which air and/or the cut-through band can be sucked off.

22. The apparatus according to claim 21, wherein the support element has a cross section which tapers toward the opening of the support element, so that the bundle lying on the support element upon a sucking of air through the opening adapts itself at least partly to the tapering cross section of the support element and is in the process concavely bulged.

23. A value-document processing system having at least one apparatus for processing value documents and having an apparatus according to claim 13.

24. A method for separating a band of a bundle of documents, comprising:
deforming the bundle is deformed such that a portion of the band lifts from the bundle, and
cutting through the band at least partly in the region of the portion lifted from the bundle.
